(19) United States
(12) Patent Application Publication
(10) Pub. No.: US 2011/0304948 A1
(43) Pub. Date: Dec. 15, 2011

(54) CAPACITOR FOR INVERTER OF VEHICLE

(75) Inventors: Jeong Yun Lee, Hwaseong (KR); Hong Seok Song, Seongnam (KR); Ki Young Jang, Hwaseong (KR); Jin Hwan Jung, Suwon (KR); Jung Hong Joo, Hwaseong (KR)

(73) Assignees: KIA MOTORS CORPORATION, Seoul (KR); HYUNDAI MOTOR COMPANY, Seoul (KR)

(21) Appl. No.: 12/959,497

(22) Filed: Dec. 3, 2010

(30) Foreign Application Priority Data
Jun. 10, 2010 (KR) 10-2010-0055027

(51) Int. Cl. H01G 4/002

(52) U.S. Cl. 361/301.1

(57) ABSTRACT

The present invention provides a capacitor for an inverter of a vehicle comprising a case; a plurality of capacitor unit modules; positive and negative bus plates that are disposed in the case to be connected to the capacitor unit modules; and a power module corresponding to the unit modules, wherein that the unit modules are insulated from each other through an insulating material, and wherein the bus plates each comprise a bus bar that overlaps with the other bus bar and is electrically connected to the power module.

### CROSS-REFERENCE TO RELATED APPLICATION

This application claims priority to and the benefit under 35 U.S.C. §119(a) of Korean Patent Application No. 10-2010-0055027 filed in the Korean Intellectual Property Office on Jun. 10, 2010, the entire contents of which are incorporated herein by reference.

### BACKGROUND OF THE INVENTION

(a) Field of the Invention

The present invention relates to an inverter system used for a hybrid vehicle or a fuel cell vehicle. More particularly, the present invention relates to a bus bar of a capacitor absorbing a ripple current.

(b) Description of the Related Art

Recently, hybrid vehicles and fuel cell vehicles substituting for internal combustion engine vehicles have been in the spotlight in terms of green energy.

As a power source, a high powered motor is applied to hybrid vehicles and fuel cell vehicles, and an inverter system is applied thereto to transform high voltage DC power generating from a battery or a fuel cell to 3-phase (U, V, and W phase) AC power so as to charge/discharge electrical energy.

The inverter system is equipped with a capacitor for absorbing a ripple current by switching a semiconductor switching element such as an insulated gate bipolar transistor (IGBT) power module that consists of a power transformation switching element (IGBT).

The capacitor as stated above generally includes a high voltage DC input terminal as an input element of the inverter, and positive and negative bus plates electrically connected to the IGBT power module.

In general, an epoxy resin is molded between the flat plate bodies forming the positive and negative bus plates; and positive and negative bus bars protrude at an edge end of the bodies to be connected to the IGBT power module, wherein the bus bars are not overlapped but are disposed in parallel with each other.

However, in this arrangement, since the bus bars of the positive and negative bus plates are not overlapped and are disposed in parallel with each other, the problem of parasitic inductance of the capacitor is observed and increased.

Parasitic inductance is a factor for increasing the terminal voltage of the IGBT power module. Such increased terminal voltage can damage the IGBT power module, and the increased terminal voltage can deteriorate the electromagnetic wave performance of the inverter system.

Also, since the bus bars of the positive and negative bus plates are exposed, a problem is observed in which the bus bars are oxidized in air or mechanically abraded such that a short circuit of the IGBT power module can be caused by a foreign material.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a capacitor for an inverter of a vehicle having advantages of reducing parasitic inductance by minimizing magnetic flux leakage between bus plates; preventing damage to a power module by a terminal voltage increment of an IGBT power module; and reducing incidence of a short circuit of a bus bar of the IGBT power module.

In one aspect the invention provides, a capacitor for an inverter of a vehicle comprising:
a case;
a plurality of capacitor unit modules;
positive and negative bus plates that are disposed in the case and connected to the capacitor unit modules; and
a power module corresponding to the unit modules,
wherein the unit modules are insulated from each other through an insulating material, and
wherein the bus plates each comprise a bus bar that overlaps with the other bus bar and is electrically connected to the power module.

In certain embodiments, the respective bus plates may comprise a plate body. In certain other embodiments, the bus bar is formed at an edge end of the plate body.

In still over embodiments, the bus bars may each comprise an overlapped portion that is extended outside of the edge end of the plate body to be overlapped with each other, and a terminal portion that is integrally formed with the overlapped portion to be electrically connected to the power module.

In yet other embodiments, each overlapped portion may be extended upwards from the edge end based on the flat surface of the plate body, and then bent downwards.

In another embodiment, the insulation material may comprise an epoxy resin that can be hardened between the positive and negative bus plates.

In still another embodiment, the terminal portions of the respective bus bars may be coated by epoxy resin.

In another aspect, the invention provides a capacitor for an inverter of a vehicle comprising an overlapped portion of a bus bar of a positive and negative bus plate insulated by insulation material such that the magnetic flux leakage between them can be minimized.

Accordingly, in one embodiment of the invention, the magnetic flux leakage between the positive and negative bus plates is minimized such that the parasitic inductance is reduced; the spike voltage of the power module is reduced such that a increment of the terminal voltage of the power module is minimized to prevent the damage thereof; deterioration of the electromagnetic wave performance of the inverter is prevented.

Also, in another embodiment of the invention, and without being limited by theory, since a hardened insulation material is formed between the overlapped portions of the positive and negative bus plate, moisture cannot invade into the overlapped portion, thereby preventing the insulation material from being decomposed in moisture and preventing a short circuit of the bus bar for the power module.

In still other embodiments, an epoxy resin is coated on a terminal portion of positive and negative bus plates such that the terminal portion is prevented from being short circuited by mechanical abrasion and corrosion.

The above and other features and advantages of the present invention will be apparent from or are set forth in more detail in the accompanying drawings, which are incorporated in and form a part of this specification, and the following Detailed Description, which together serve to explain by way of example the principles of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWINGS

While the drawings are described in connection with what is presently considered to be practical exemplary embodiments, it is to be understood that the invention is not limited to the disclosed drawings.

FIG. 1 is an assembly perspective view showing a capacitor for an inverter of a vehicle according to an exemplary embodiment of the present invention.

FIG. 2 is an exploded view of FIG. 1.

FIG. 3 is a front schematic diagram of FIG. 1.

FIG. 4 is a side schematic diagram of FIG. 1.

### DESCRIPTION OF SYMBOLS

Reference numerals set forth in the Drawings includes reference to the following elements as further discussed below:

10 . . . case

40 . . . capacitor unit module

50 . . . power module

60 . . . bus plate

61 . . . plate body

63 . . . high voltage input terminal

70 . . . bus bar

71 . . . overlapped portion

81 . . . terminal portion

90 . . . insulation material

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF THE EMBODIMENTS

Hereinafter, the present invention will be described more fully with reference to the accompanying drawings, in which exemplary embodiments of the invention are shown. As those skilled in the art would realize, the described embodiments may be modified in various different ways, all without departing from the spirit or scope of the present invention.

Portions having no relation with the description will be omitted in order to explicitly explain the present invention, and the same reference numerals will be used for the same or similar elements throughout the specification.

In the drawings, size and thickness of each element is approximately shown for better understanding and ease of description. The present invention is not limited to the drawings, and the thicknesses of layers, films, panels, regions, etc., are referenced only for clarity.

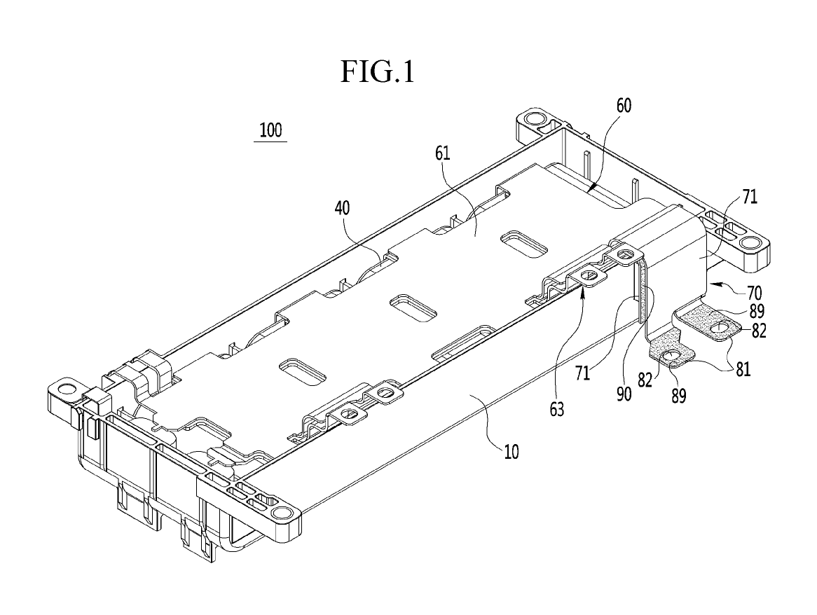

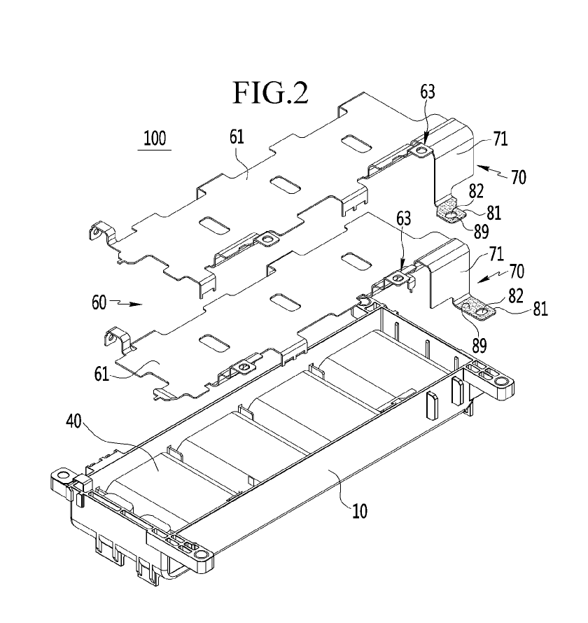

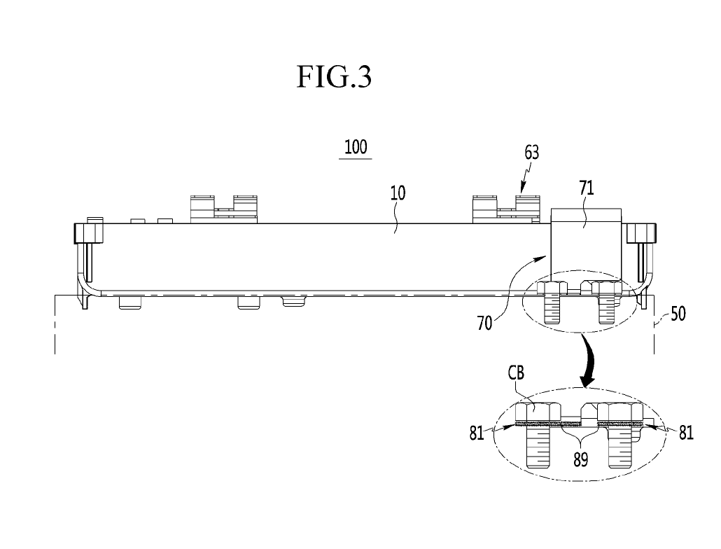

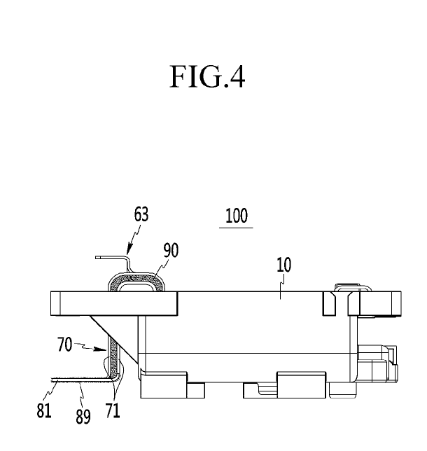

FIG. 1 is an assembly perspective view showing a capacitor for an inverter of a vehicle according to an exemplary embodiment of the present invention, FIG. 2 is an exploded view of FIG. 1, FIG. 3 is a front schematic diagram of FIG. 1, and FIG. 4 is a side schematic diagram of FIG. 1.

Referring to the above drawings, a capacitor 100 for a vehicle according to an exemplary embodiment of the present invention is applied to a hybrid vehicle to which an engine and a high power motor as a power source is applied, or to a fuel cell vehicle.

In this case, the inverter transforms a high voltage DC power generated from a battery or fuel cell to 3 phase (U, V, and W) AC power so as to control the high power motor.

The inverter includes a capacitor absorbing a ripple current, an insulated gate bipolar transistor (IGBT) power module (hereinafter, “power module” for convenience) that is composed of a power transformation switching element (IGBT), a control board for controlling speed and motor torque, and a current sensor for monitoring 3 phase AC power necessary for the control.

The capacitor 100 absorbs a ripple current generated during switching of the inverter so as to reduce a fluctuation of the inverter DC input voltage, and this enables normal operation of the inverter and increases the lifetime of a high voltage battery or a fuel cell.

The capacitor 100 according to an exemplary embodiment of the present invention minimizes parasitic inductance to enable a reduction of a spike voltage of the power module by the inductance, and this reduces a damage possibility of the power module and prevents electromagnetic wave performance of the inverter from being deteriorated.

The capacitor 100 according to an exemplary embodiment of the present invention comprises a case 10, capacitor unit modules 40, and positive and negative bus plates 60, and descriptions thereof are as follows.

In the capacitor 100, the case 10 is used for mounting all constituent elements of the capacitor 100. The case 10 has a housing shape of which the upper end is opened and may be made, for example, of an aluminum material for easily releasing heat.

The case 10 includes a plurality of mounting units for fixing constituent elements of the capacitor 100 according to the present exemplary embodiment, and can include a cover (not shown in the drawings) for covering the open upper portion.

The capacitor unit modules 40 are electrically connected to a power module 50 corresponding to a 3 phase (U, V, and W) inverter, and are mounted in the case 10 corresponding to the power module 50.

In the present exemplary embodiment, the positive and negative bus plates 60 supply the power module 50 with high voltage DC power generated from a battery or a fuel cell, and absorb a ripple current formed by switching of the power module 50.

The bus plates 60 are insulated by an insulation material 90 from each other, they includes positive and negative plate bodies 61 that are mounted in the case 10, and a high voltage input terminal 63 and a bus bar 70 are formed at an edge end of each of the plate bodies 61.

The high voltage input terminal 63 is set to supply a high voltage DC power to the power module 50, and is electrically connected to the power module 50 to be formed at one side edge end of the plate body 61.

The bus bar 70 is configured to absorb a ripple current formed by switching of a semiconductor switching element such as the power module 50 and electrically connect the power module 50 with the capacitor unit modules 40 to be formed at the other edge end of the plate body 61.

In the present exemplary embodiment, the bus bars 70 of the positive and negative bus plates 60 are configured to connect the power module 50 with the capacitor unit modules 40 by a connector bolt (CB).

The above bus bar 70 is overlapped and insulated by the insulation material 90 to be connected to the power module 50.

Each bus bar 70 includes an overlapped portion 71 that is extended at an edge end of the plate body to be overlapped and a terminal portion 81 that is integrally formed with the overlapped portion 71 to be electrically connected to the power module 50.

The overlapped portion 71 is extended upwards from the edge end and is bent downwards based on the flat surface of the plate body 61.

Each terminal portion 81 is integrally connected to a lower end of the overlapped portion 71 to be bent in a direction perpendicular to the overlapped portion 71, and an engage hole 82 through which the connector bolt (CB) can pass for engagement is formed therein.

Meanwhile, the insulation material 90 according to the present exemplary embodiment is set to insulate the positive and negative bus plates 60 and is composed of an epoxy resin that can be formed between the positive and negative bus plates 60.

In other words, the epoxy resin flows into a gap between the overlapped portions 71 of the bus bars 70 and into a gap between the plate bodies 61 with a flat shape to be coated, and the insulation material 90 can be coated on surfaces between the positive and negative bus plates 60.

Also, the epoxy resin is coated on the terminal portion 81 of each bus bar 70 in the present exemplary embodiment such that a coating layer 89 of the epoxy resin is formed on a surface of the terminal portion 81.

Accordingly, in the capacitor 100 for an inverter of a vehicle according to an exemplary embodiment of the present invention, the insulation material 90 is formed between the bus bars 70 of the positive and negative bus plates 60 to insulate the overlapped portions 71 such that magnetic flux leakage therebetween can be minimized.

Thereby, the magnetic leakage between positive and negative bus plates 60 is minimized to reduce ripple inductance thereof.

A reduction of the parasitic inductance reduces a spike voltage of the power module 50 and minimizes a terminal voltage of the power module 50 such that damage to the power module 50 is prevented and the electromagnetic wave performance of the inverter is improved.

In this case, since the terminal voltage of the power module 50 is proportional to the parasitic inductance, the lower the parasitic inductance, the more reduced the terminal voltage, and the terminal voltage of the power module 50 is reduced according to the reduction of the parasitic inductance in the present exemplary embodiment to decrease a possibility of damage to the power module 50 by the terminal voltage.

Since the epoxy resin flows into a gap between the overlapped portions 71 of the positive and negative bus plates 60 to form a hardened insulation material 90 in the present exemplary embodiment, decomposition in water of the insulation material 90 can be prevented, and resultantly a short circuit of the bus bar 70 is prevented in advance.

In addition, since the epoxy resin is coated on the terminal portions 81 of the positive and negative bus plates 60 in the present exemplary embodiment, oxidation thereof by air, mechanical abrasion, and a short circuit of the terminal portions 81 caused by a foreign material are effectively prevented in advance.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A capacitor for an inverter of a vehicle, comprising:
a case;
a plurality of capacitor unit modules;
positive and negative bus plates that are disposed in the case and connected to the capacitor unit modules; and
a power module corresponding to the unit modules,
wherein the unit modules are insulated from each other through an insulating material, and
wherein the bus plates each comprise a bus bar that are overlaps with the other bus bar and is electrically connected to the power module.

2. The capacitor of claim 1, wherein the respective bus plates comprise a plate body, and wherein the bus bar is formed at an edge end of the plate body.

3. The capacitor of claim 2, wherein the bus bars each comprise an overlapped portion that is extended outside of the edge end of each plate body to be overlapped with each other, and a terminal portion that is integrally formed with the overlapped portion to be electrically connected to the power module.

4. The capacitor of claim 3, wherein each overlapped portion is extended upwards from the edge end based on the flat surface of the plate body, and then bent downwards.

5. The capacitor of claim 1, wherein the insulation material comprises epoxy resin that can be hardened between the positive and negative bus plates.

6. The capacitor of claim 3, wherein the terminal portions of the respective bus bars are coated by an epoxy resin.
